(19) United States
(12) Patent Application Publication
(10) Pub. No.: US 2009/0265392 A1
(43) Pub. Date: Oct. 22, 2009

(54) Data verifying device, data verifying method, and data verifying program

(75) Inventors: Kazumasa Taneike, Kawasaki (JP); Masahiko Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/457,760

(22) Filed: Jun. 19, 2009

Related U.S. Application Data
(63) Continuation of application No. PCT/JP2006/325642, filed on Dec. 22, 2006.

(51) Int. Cl. G06F 17/30

(52) U.S. Cl. 707/200; 707/101; 707/10; 707/E17.009; 707/E17.005; 707/E17.01

(57) ABSTRACT

A data verifying device collects various types of detailed data for each work processing unit (e.g., for each processing unit such as order acceptance and shipping), normalizes the collected various types of detailed data, and registers the detailed data into a defined work detailed database or a work procedure record detailed database, through an ESB. On receiving an execution instruction of a verification process from an administrator or the like the data verifying device verifies the consistency of a plurality of pieces of detailed data registered in the defined work detailed database based on a verification dictionary master included therein.

### CROSS-REFERENCE TO RELATED APPLICATION(S)

This application is a continuation of PCT international application Ser. No. PCT/JP2006/325642 filed on Dec. 22, 2006 which designates the United States, the entire contents of which are incorporated herein by reference.

### FIELD

The embodiment(s) discussed herein is (are) directed a data verifying device, a data verifying method and a data verifying program that verify data in work processes for a work service including a plurality of stages of work processes.

### BACKGROUND

Companies have used conventional technologies for entering data written on slips and the like in a computer, storing the data as electronic data in the computer, and outputting the data as necessary. For example, Japanese Laid-open Patent Publication No. 05-101081 discloses a technology for storing data associated with slips entered with terminal devices while determining the validity of the data, increasing the speed of data processing, and ensuring the reliability of the data.

In conventional audit services carried out in companies, for example, auditors collect data associated with intra-firm dealings or the like. Accordingly, the audit is performed based on a criterion whether auditors have received impressions that no irregularity occurs.

However, because such a conventional audit is performed based on impressions made on auditors, a problem occurs in that a fair amount of time is required to carry out the operation.

Standards on evaluation of internal control over financial recording and on auditing are published by the Business Accounting Council to force listed companies to abide by in and after 2008. Accordingly, a mechanism to enhance internal control and auditing is required.

### SUMMARY

According to an aspect of an embodiment, a data verifying device that verifies data in a work process, for a work service including a plurality of stages of work processes, includes a data collecting unit that collects data for each work processing unit; a data normalizing unit that, when the data collecting unit collects data associated with a work process in a subsequent stage that has taken over a work process in a prior stage, normalizes the data by assigning link information to link the data associated with the work process in the prior stage and the data associated with the work process in the subsequent stage as a series of data; a data storage unit that stores therein data associated with the work process with the link information assigned by the data normalizing unit; a data verifying unit that reads the series of data linked by the link information from a plurality of pieces of data stored in the data storage unit, and verifies consistency of the series of data based on a predetermined verification condition; and a verification result output unit that outputs a verification result obtained by the data verifying unit.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF DRAWING(S)

FIG. 1 is a schematic for explaining an outline and characteristics of a data verifying device according to a first embodiment;

FIG. 2 is a conceptual diagram of flows of collection and normalization of detailed data according to the first embodiment;

FIG. 3 is a schematic of a configuration example of a verification dictionary master according to the first embodiment;

FIG. 4 is a schematic of an example of verification of a plurality of pieces of detailed data according to the first embodiment;

FIG. 5 is a block diagram of a configuration of the data verifying device according to the first embodiment;

FIG. 6 is a schematic of a configuration example of information stored in a defined work detailed database according to the first embodiment;

FIG. 7 is a schematic of an output example of the verification result according to the first embodiment;

FIG. 8 is a flowchart of a processing flow of collection and normalization of the detailed data according to the first embodiment;

FIG. 9 is a flowchart of a processing flow of the verification according to the first embodiment;

FIG. 10 is a schematic of a configuration example of a verification dictionary master according to a second embodiment;

FIG. 11 is a schematic of a configuration of information stored in a defined work detailed database according to the second embodiment;

FIG. 12 is a flowchart of a processing flow of the verification according to the second embodiment;

FIG. 13 is a schematic of an example of format conversion of detailed data according to a third embodiment;

FIG. 14 is a schematic of a configuration example of information stored in a defined work detailed database according to the third embodiment;

FIG. 15 is a flowchart of a processing flow of collection and normalization of the detailed data according to the third embodiment; and

FIG. 16 is a schematic of a computer that implements a data verifying program.

### DESCRIPTION OF EMBODIMENT(S)

Exemplary embodiments of a data verifying device, a data verifying method, and a data verifying program according to the present invention are described below in detail with reference to the accompanying drawings. Main terminologies used in the present embodiments are described (explanation of terminologies), and a data verifying device according to the present invention is described as a first embodiment of the present invention. Other embodiments of the present invention will be described later.

Main terminologies used in the present embodiments will now be described. An “enterprise service bus (ESB)” used in the present embodiments is a sophisticated processing program based on a service-oriented architecture (SOA). The SOA is a system architecture that allows software units or components and their functions to flexibly coordinate, depending on a structural unit of a business process. A system can be configured so that data is exchanged among work systems (such as a sales system and a production system), through the ESB that is a virtual message bus.

An “extensible markup language (XML)” used in the present embodiments is one of the languages used to describe the meaning and the structure of a document or data. The XML has a language structure with which a user can define tags at will, and can give a meaning to a string of characters in a document. The advantage of the XML lies in that information on XML data can be processed at will, using a computer program.

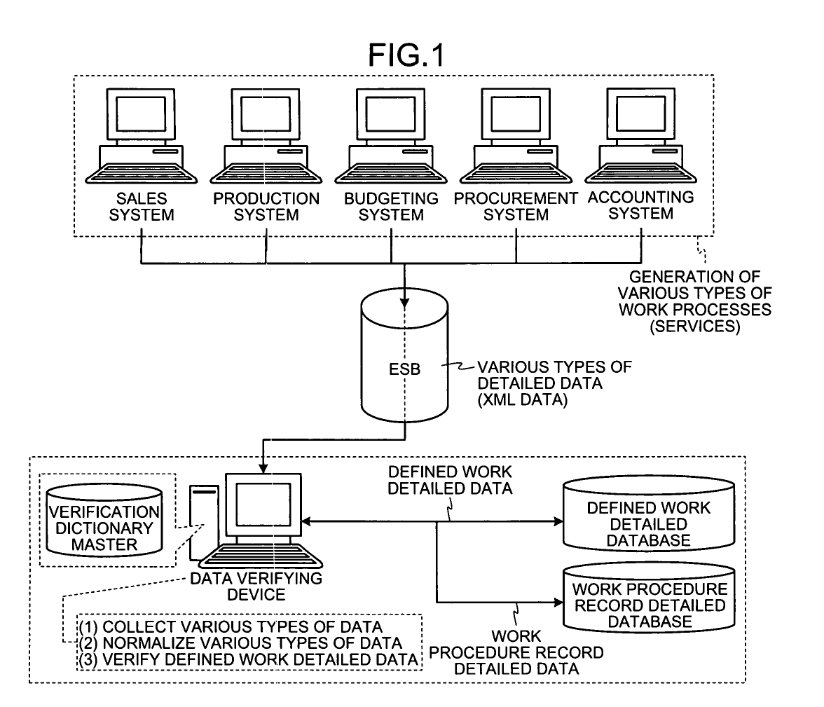

With reference to FIG. 1, an outline and characteristics of a data verifying device according to a first embodiment will be described. FIG. 1 is a schematic for explaining the outline and characteristics of the data verifying device according to the first embodiment.

The outline of the data verifying device according to the first embodiment, after an order is accepted, is to verify data in work processes for a work service including a plurality of stages of work processes, such as shipment processing. The main characteristics of the data verifying device is to easily verify data associated with intra-firm dealings or the like that have been handled manually, and to verify the consistency of a plurality of pieces of data.

The main characteristics will be described in greater detail. As depicted in FIG. 1, the data verifying device according to the first embodiment is communicably connected to a sales system, a production system, a budgeting system, a procurement system, and an accounting system. The data verifying device according to the first embodiment includes a defined work detailed database and a work procedure record detailed database. The defined work detailed database stores therein defined work detailed data (such as accounting data recorded in an accounting system and work data recorded in systems). The work procedure record detailed database stores therein work procedure record detailed data (such as work procedure data associated with an order entry process and an order approval process performed as order acceptance processes).

When various types of work processes are required in systems, the data verifying device according to the first embodiment collects various types of detailed data for each work processing unit (e.g., for each processing unit such as order acceptance and shipping) (see (1) in FIG. 1), and normalizes the collected various types of detailed data (see (2) in FIG. 1) through the ESB. The data verifying device then registers the detailed data into the defined work detailed database or the work procedure record detailed database.

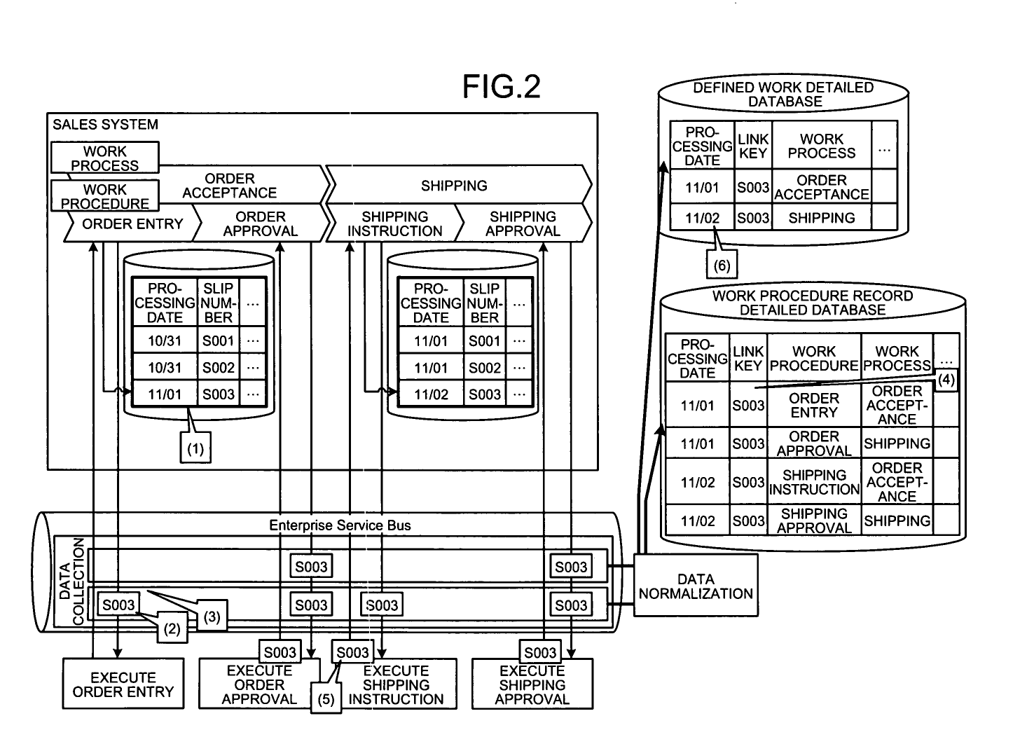

More specifically, as depicted in FIG. 2, for example, in a sales system that has received an order entry instruction associated with an order acceptance process from an administrator or the like, when detailed data numbered with a slip number is registered into a database (see (1) in FIG. 2), the data verifying device according to the first embodiment collects detailed data of the order entry process that flows through the ESB, and obtains the slip number from the detailed data (see (2) in FIG. 2).

The data verifying device according to the first embodiment then determines a registration destination of the data, based on a work process name on the collected detailed data (see (3) in FIG. 2), and registers the detailed data normalized by assigning the slip number obtained from the detailed data thereto as a link key into the database (see (4) in FIG. 2). For example, as depicted in FIG. 2, if the work process name of the detailed data is an “order entry”, the data verifying device determines that the detailed data needs to be registered in the work procedure record detailed database as a work procedure, and registers the detailed data normalized by assigning the slip number thereto as a link key into the work procedure record detailed database.

Subsequent to the order entry process, when an order approval process is executed by the sales system that has received an order approval instruction to which a slip number the same as that on the detailed data of the order entry process is specified, from an administrator or the like, the data verifying device according to the first embodiment collects the detailed data of the order approval process that flows through the ESB, and obtains the slip number from the detailed data similar to when the order entry process is executed in the sales system. The data verifying device then determines a registration destination of the data, based on a work process name on the collected detailed data, and registers the detailed data normalized by assigning the slip number obtained from the detailed data thereto as a link key into the database.

For example, as depicted in FIG. 2, the data verifying device according to the first embodiment determines, if a work process name of the detailed data is an “order approval”, that the detailed data needs to be registered in the work procedure record detailed database as a work procedure, and registers the detailed data normalized by assigning the slip number thereto as a link key into the work procedure record detailed database.

Because the order acceptance process is defined by the “order approval”, the data verifying device according to the first embodiment determines that the detailed data up to the order approval process needs to be registered into the defined work detailed database as well, and registers the detailed data normalized by assigning the slip number thereto as a link key into the defined work detailed database.

Subsequent to the order acceptance process, in the sales system that has received a shipping instruction associated with a shipping process to which a slip number the same as that on the detailed data of the order acceptance process (order entry process and order approval process) is specified, from an administrator or the like (see (5) in FIG. 2), when the detailed data numbered with a slip number the same as that on the detailed data of the order acceptance process is registered into the database, the data verifying device according to the first embodiment collects the detailed data of a shipping instruction process that flows through the ESB, and obtains the slip number from the detailed data as described in the order acceptance process. The data verifying device then determines a registration destination of the data, based on a work process name on the detailed data of the collected shipping instruction process, and registers the detailed data normalized by assigning the slip number obtained from the detailed data thereto as a link key into the database. For example, if the work process name of the detailed data is a “shipping instruction”, the data verifying device determines that the detailed data needs to be registered in the work procedure record detailed database as a work procedure, and registers the detailed data normalized by assigning the slip number thereto as a link key into the work procedure record detailed database.

Subsequent to the shipping instruction process, when a shipping approval process is executed by the sales system that has received a shipping approval instruction to which a slip number the same as that on the detailed data of the shipping instruction process is specified, from an administrator or the like, the data verifying device according to the first embodiment collects the detailed data of the order approval process that flows through the ESB, and obtains the slip number from the detailed data as described in the order acceptance process. The data verifying device then determines a registration destination of the data based on a work process name on the collected detailed data of the shipping approval process, and registers the detailed data normalized by assigning the slip number obtained from the detailed data thereto as a link key.

For example, the data verifying device according to the first embodiment determines, if the work process name of the detailed data is a “shipping approval”, that the detailed data needs to be registered in the work procedure record detailed database as a work procedure. Because the process of shipping is defined by the “shipping approval”, the data verifying device determines that the detailed data up to the shipping approval process needs to be registered into the defined work detailed database as well. Accordingly the data verifying device registers the detailed data normalized by assigning the slip number thereto as a link key into the work procedure record detailed database and the defined work detailed database (see (6) in FIG. 2).

In this manner, the data verifying device according to the first embodiment can register the detailed data of the processes from the order acceptance to the collection or shipping, into the databases as a series of data, by using a slip number as a link key. Although not depicted in the drawings, work operation record data such as “activation of a screen”, a “person who issued a slip”, and a “name of a slip issuing terminal” is also collected.

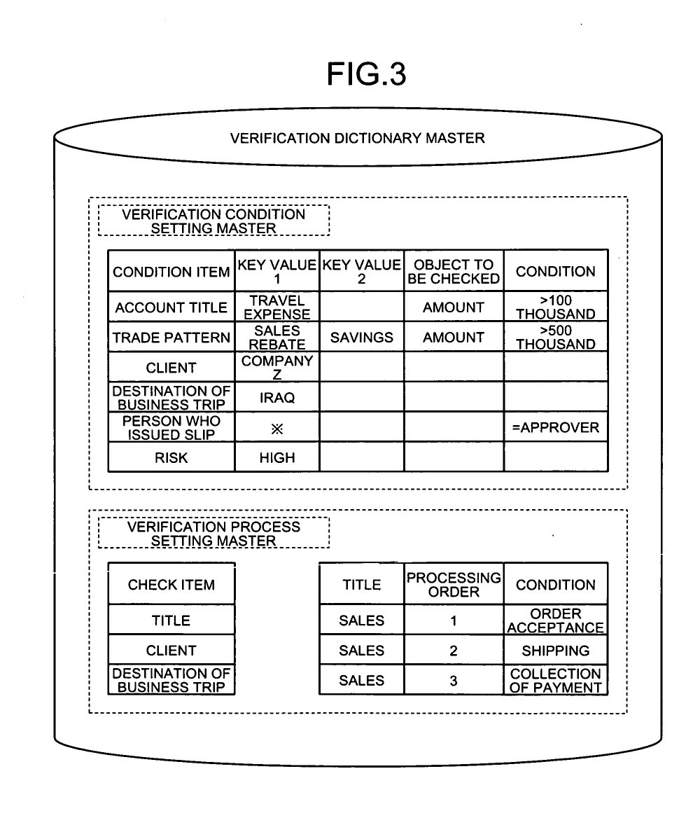

The data verifying device according to the first embodiment verifies, for example, on receiving an execution instruction of a verification process from an administrator or the like, the consistency of a plurality of pieces of detailed data registered in the defined work detailed database based on a verification dictionary master (see FIG. 3) included therein (see (3) in FIG. 1).

More specifically, the data verifying device according to the first embodiment reads a series of data linked by a link key from the defined work detailed database. The data verifying device then rearranges the series of data read from the defined work detailed database based on a verification process setting master in the verification dictionary master (see FIG. 3). For example, if a series of data formed by the detailed data on “order acceptance”, the detailed data on “shipping”, and the detailed data on “collection of payment” listed under an account title “sales” is to be verified, the data verifying device rearranges the read series of data in the sequence of “order acceptance”, “shipping”, and “collection of payment”. This is carried out based on the processing order set for the “sales” of a check item “title” in the verification process setting master (for example, if the condition is “order acceptance”, the processing order is “1”; if the condition is “shipping”, the processing order is “2”; and if the condition is “collection of payment”, the processing order is “3”).

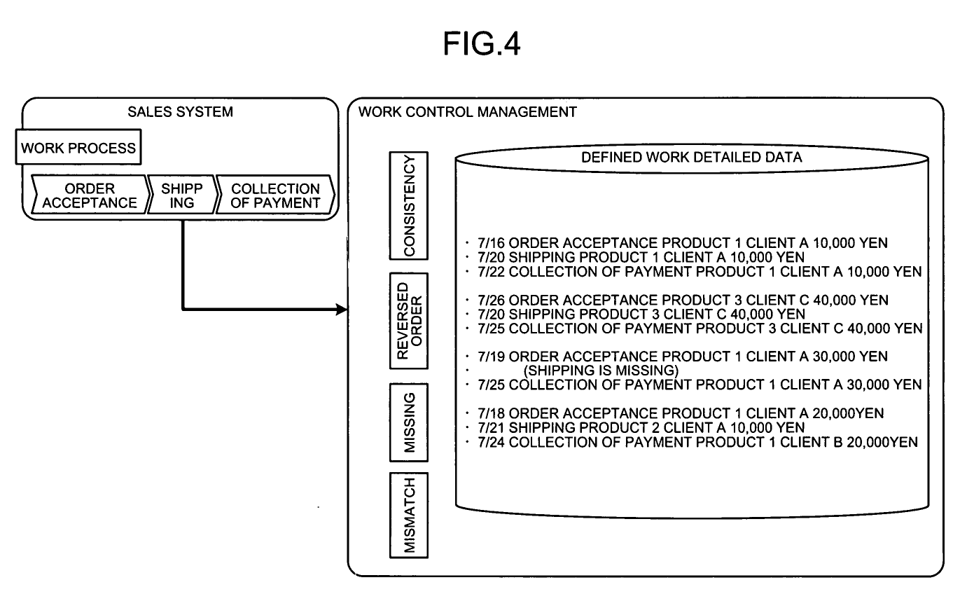

After rearranging the series of data, the data verifying device according to the first embodiment verifies if a problem occurs with the consistency of the rearranged series of data. For example, as depicted in FIG. 4, the data verifying device compares the processing dates (such as a date on a slip) in the descending order, and verifies discrepancies between old and new processing dates (for example, a discrepancy occurs when the processing date of “collection of payment” is later than the processing date of “shipping”), a part of work processes missing from the series of data (such as missing of data on a “work process” of shipping), and mismatching data elements among some pieces of data (such as mismatching product names and clients).

As a result of the verification, if a problem occurs with the consistency of the series of data, the data verifying device according to the first embodiment writes check information in the defined work detailed database on the data that has a problem with consistency. With a readable series of data (for example, a series of data whose final recording is finished), the data verifying device continuously reads the readable series of data from the defined work detailed database, and as described above, verifies if a problem occurs with the consistency of the series of data.

The use of the data verifying device according to the first embodiment is not limited to verifying the consistency of a plurality of pieces of detailed data. The data verifying device may also verify the consistency of the content of each piece of the detailed data (e.g., each piece of the detailed data associated with work processes such as “order acceptance” and “shipping”) that forms a series of data based on a verification condition setting master in the verification dictionary master (see FIG. 3). If the read detailed data includes detailed data with an account title “travel expense”, the data verifying device checks the amount, and for example, if the amount is equal to or more than one hundred thousand yen, writes check information in the defined work detailed database indicating that the data has a problem with consistency.

The data verifying device according to the first embodiment reads, on finishing the verification process for the consistency of the pieces of detailed data registered in the defined work detailed database, the detailed data to which check information is written, from the defined work detailed database, and outputs the verification result.

In this manner, the data verifying device according to the first embodiment can easily verify data associated with intra-firm dealings or the like that have been handled manually, and can also verify the consistency of the pieces of data.

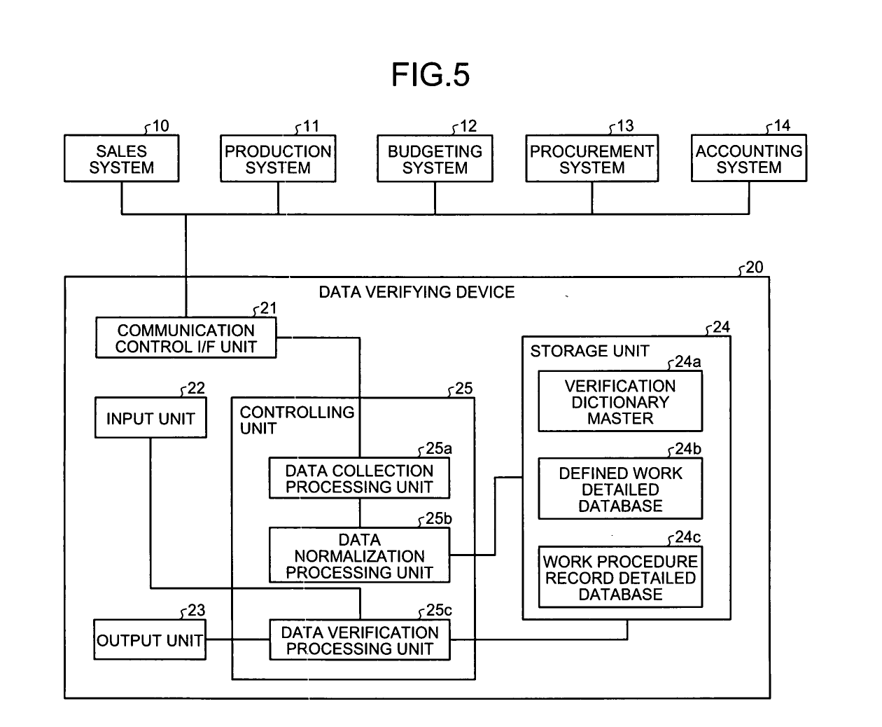

With reference to FIG. 5, a configuration of the data verifying device according to the first embodiment will be described. FIG. 5 is a block diagram of the configuration of the data verifying device according to the first embodiment. As depicted in the drawings, a data verifying device 20 according to the first embodiment is communicably connected to a sales system 10, a production system 11, a budgeting system 12, a procurement system 13, and an accounting system 14. The data verifying device 20 according to the first embodiment includes a communication control interface (I/F) unit 21, an input unit 22, an output unit 23, a storage unit 24, and a controlling unit 25.

The communication control I/F unit 21 controls communication related to detailed data exchanged among systems. The input unit 22 receives entries of various types of information and an entry of an instruction to execute a process from an administrator or the like of the data controlling device 20. The input unit 22 includes a keyboard, a mouse, and a microphone, and for example, receives an input of an instruction to execute verification of the consistency of a plurality of pieces of detailed data. The output unit 23 outputs various types of information, and includes a monitor (or a display or a touch panel) and a speaker. The output unit 23, for example, displays and outputs the verification result on the consistency of the pieces of detailed data.

The storage unit 24 stores therein data and a computer program required for various types of processing performed by the controlling unit 25. As those most closely associated with the present invention, the storage unit 24 includes a verification dictionary master 24a, a defined work detailed database 24b, and a work procedure record detailed database 24c.

The verification dictionary master 24a is data used to verify, for example, the consistency of a plurality of pieces of detailed data carried out by a data verification processing unit 25c, which will be described later. The verification dictionary master 24a includes a verification condition setting master and a verification process setting master.

More specifically, as depicted in FIG. 3, in association with condition items (such as an “account title” and a “client”) of the verification process, the verification condition setting master stores therein a key value (such as a key value 1 “travel expense” and a key value 2 “savings”) to narrow down data, an object to be checked (such as an “amount”), and verification content (such as whether the amount of the travel expense in the account title that is to be checked exceeds one hundred thousand yen). The verification process setting master stores therein a processing order that is the sequence of work processes and a condition that is work content, for each check item (such as a “title” and a “client”) set to execute the verification process.

The data in the verification condition setting master and the verification process setting master of the verification dictionary master can be suitably set by a user.

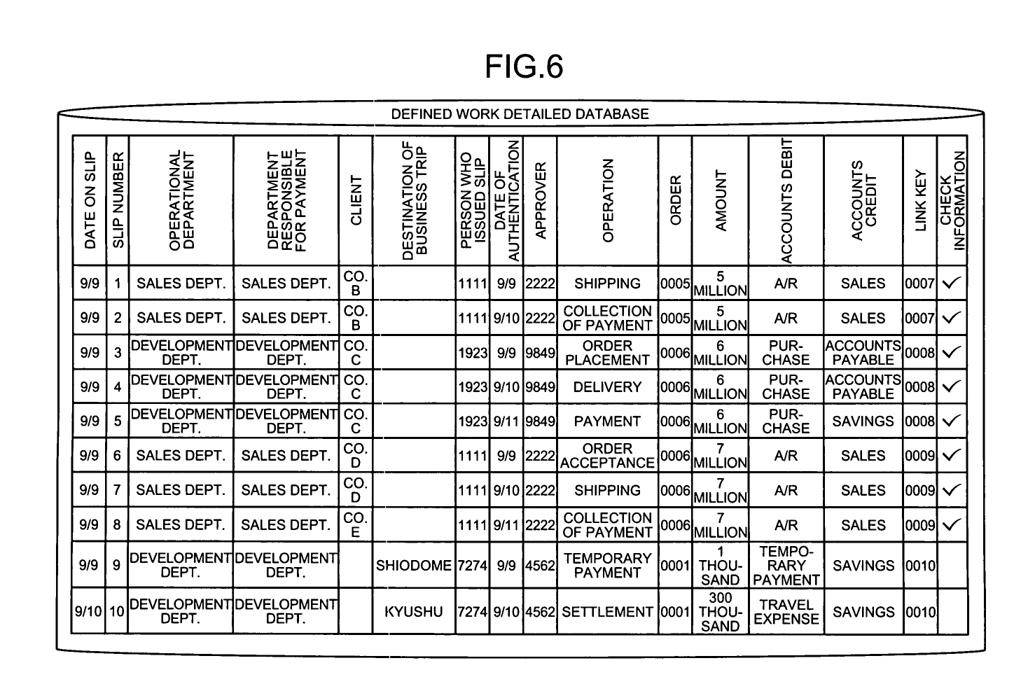

The defined work detailed database 24b stores therein defined work detailed data (such as accounting data recorded in an accounting system and work data recorded in systems). More specifically, as depicted in FIG. 6, the defined work detailed database 24b stores therein “date on slip”, “slip number”, “operational department”, “department responsible for payment”, “client”, “destination of business trip”, “person who issued a slip”, “date of authentication”, “approver”, “operation”, “order”, “amount”, “accounts debit”, “accounts credit”, “link key”, “check information”, and the like, in an associated manner.

The work procedure record detailed database 24c stores therein work procedure record detailed data (such as work procedure data associated with an order entry process and an order approval process carried out as order acceptance processes) (see FIG. 2).

The controlling unit 25 is a processing unit that includes an internal memory to store therein a certain controlling program, a computer program in which various types of processing procedures are defined, and required data, and executes various kinds of processing using them as a processing unit. As those most closely associated with the present invention, the controlling unit 25 includes a data collection processing unit 25a, a data normalization processing unit 25b, and the data verification processing unit 25c.

The data collection processing unit 25a is a processing unit that collects various types of detailed data for each work processing unit (e.g., for each processing unit such as order acceptance and shipping) through the ESB. More specifically, for example, in the sales system that has received an order entry instruction associated with an order acceptance process from an administrator or the like, when the detailed data numbered with a slip number is registered in the database, the data collection processing unit 25a collects the detailed data of the order entry process that flows through the ESB, and obtains the slip number from the detailed data (see (1) and (2) in FIG. 2).

Subsequent to the order entry process, when an order approval process is executed by the sales system that has received an order approval process instruction to which a slip number the same as that on the detailed data of the order entry process is specified, from an administrator or the like, the data collection processing unit 25a collects the detailed data of the order approval process that flows through the ESB, and obtains the slip number from the detailed data. Similarly, the data collection processing unit 25a collects the detailed data of a shipping instruction process and a shipping approval instruction process to which a slip number the same as that on the detailed data of the order acceptance process is specified, from the ESB, and obtains the slip number from each piece of the detailed data. Work operation record data such as “activation of a screen”, a “person who issued a slip”, and a “name of a slip issuing terminal” that will not be used by the data verification processing unit 25c, which will be described later, for verifying the pieces of detailed data, is also collected.

The data normalization processing unit 25b normalizes various types of detailed data collected by the data collection processing unit 25a. More specifically, the data normalization processing unit 25b determines a registration destination of detailed data based on a work process name on the detailed data collected by the data collection processing unit 25a, and registers the detailed data normalized by assigning the slip number obtained from the detailed data thereto as a link key into the database (see (3) and (4), for example, in FIG. 2). For example, as depicted in FIG. 2, if the work process name of the detailed data is an “order entry”, the data normalization processing unit 25b determines that the detailed data needs to be registered in the work procedure record detailed database 24c as a work procedure, and registers the detailed data normalized by assigning the slip number thereto as a link key into the work procedure record detailed database 25b (or 24c).

When the data collection processing unit 25a collects the detailed data of the order approval process to which a slip number the same as that on the detailed data of the order entry process is specified, from the ESB, the data normalization processing unit 25b determines that the detailed data needs to be registered in the work procedure record detailed database 24c as a work procedure, and registers the detailed data normalized by assigning the slip number thereto as a link key into the work procedure record detailed database 24c. Because the order acceptance process is defined by the “order approval”, the data normalization processing unit 25b determines that the detailed data up to the order approval process needs to be registered in the defined work detailed database 24b as well. Accordingly, the data normalization processing unit 25b registers the detailed data normalized by assigning the slip number thereto as a link key into the defined work detailed database 24b.

Similarly, when each piece of the detailed data of the shipping process (shipping instruction execution process and shipping approval execution process) to which a slip number the same as that on the detailed data of the order acceptance process (order entry process and order approval process) is specified, is collected from the ESB, the data normalization processing unit 25b obtains the slip number from the detailed data. The data normalization processing unit 25b then determines a registration destination of the data based on a work process name on each piece of the detailed data, and registers the detailed data normalized by assigning the slip number obtained from the detailed data thereto as a link key into the defined work detailed database 24b or the work procedure record detailed database 24c.

The processes performed by the data collection processing unit 25a and the data normalization processing unit 25b are repeatedly executed while the power of the data verifying device 20 is turned on. The data normalization processing unit 25b may automatically register the work process name in the item “operation” based on the work process name on the detailed data collected by the data collection processing unit 25a.

The data verification processing unit 25c, for example, on receiving an execution instruction of a verification process from an administrator or the like, based on the verification dictionary master (see FIG. 3) read from the storage unit 24, verifies, for example, the consistency of the pieces of detailed data registered in the defined work detailed database 24b.

The verification process will now be described in detail. The data verification processing unit 25c reads a series of data linked by a link key from the defined work detailed database 24b. Then, based on the verification process setting master of the verification dictionary master (see FIG. 3), the data verification processing unit 25c rearranges the series of data read from the defined work detailed database 24b. For example, when the series of data formed by the detailed data on “order acceptance”, the detailed data on “shipping”, and the detailed data on “collection of payment” listed under the account title “sales” is to be verified, the data verification processing unit 25c rearranges the read series of data in the sequence of “order acceptance”, “shipping”, and “collection of payment”. This is carried out based on the processing order set for the “sales” of the check item “title” of the verification process setting master (for example, if the condition is “order acceptance, the processing order is “1”; if the condition is “shipping”, the processing order is “2”; and if the condition is “collection of payment”, the processing order is “3”).

After rearranging the series of data, the data verification processing unit 25c verifies if a problem occurs with the consistency of the rearranged series of data. For example, the data verification processing unit 25c compares the processing dates (such as a date on a slip) in the descending order, and verifies discrepancies between old and new processing dates (for example, a discrepancy occurs when the processing date of “collection of payment” is later than the processing date of “shipping”), a part of work processes missing from the series of data (such as missing of data on a “work process” of shipping), and mismatching data elements among some pieces of data (such as mismatching product names and clients) (see FIG. 4).

As a result of verification, if a problem occurs with the consistency of the series of data, the data verification processing unit 25c writes check information in the defined work detailed database 24b, for the data that has a problem with consistency. If a readable series of data exists (for example, if a series of data whose final recording is finished exists), the data verification processing unit 25c continuously reads the series of data that can be read from the defined work detailed database 24b, and as described above, verifies if a problem occurs with the consistency of the series of data.

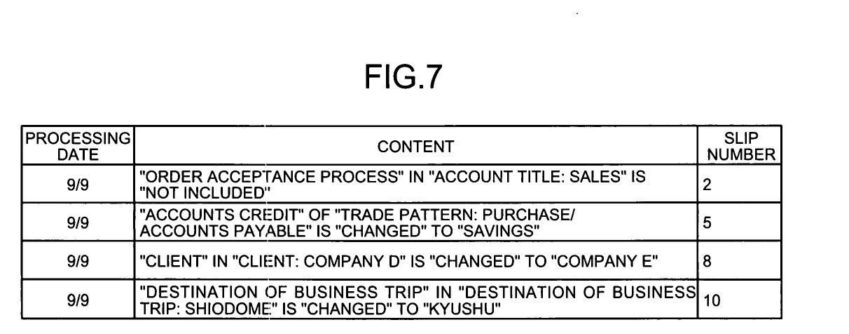

The data verification processing unit 25c reads, on finishing the verification process for the consistency of the pieces of detailed data registered in the defined work detailed database 24b, the detailed data to which check information is written from the defined work detailed database 24b. The data verification processing unit 25c, for example, as depicted in FIG. 7, then outputs the verification result including the processing date that is the date on a slip, specific checked items, and the slip number.

The use of the data verification processing unit 25c is not limited to verifying the consistency of the pieces of detailed data. The data verification processing unit 25c may also verify the consistency of the content of each piece of the detailed data (e.g., each piece of the detailed data associated with work processes such as “order acceptance” and “shipping”) that forms a series of data, based on the verification condition setting master of the verification dictionary master (see FIG. 3). If the read detailed data includes detailed data with an account title “travel expense”, the data verification processing unit 25c checks the amount, and for example, if the amount is equal to or more than one hundred thousand yen, writes check information in the defined work detailed database indicating that the data has a problem with consistency.

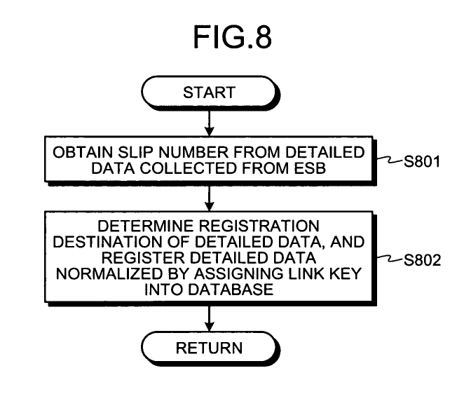

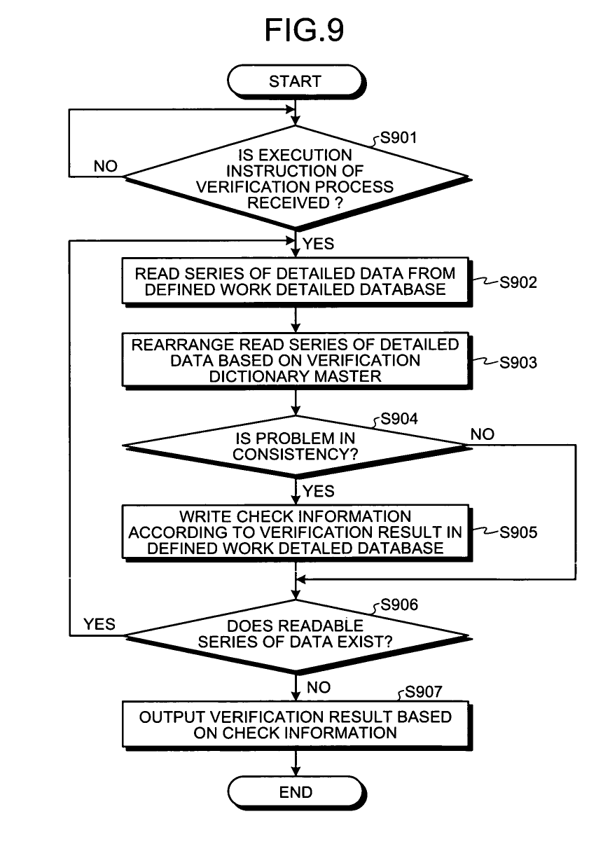

With reference to FIGS. 8 and 9, processing performed by the data verifying device according to the first embodiment will be described. FIG. 8 is a flowchart of a processing flow of collection and normalization of the detailed data according to the first embodiment. FIG. 9 is a flowchart of a processing flow of the verification according to the first embodiment.

With reference to FIG. 8, a processing flow of collection and normalization of the detailed data according to the first embodiment will be described. As represented in the flowchart, the data collection processing unit 25a collects detailed data that flows through the ESB, and obtains a slip number from the detailed data (Step S801).

More specifically, for example, in the sales system that has received an order entry instruction associated with an order acceptance process from an administrator or the like, when the detailed data numbered with a slip number is registered in the database, the data collection processing unit 25a collects the detailed data of the order entry process that flows through the ESB and obtains the slip number from the detailed data.

Subsequent to the order entry process, when an order approval process is carried out by the sales system that has received an order approval instruction to which a slip number the same as that on the detailed data of the order entry process is specified, from an administrator or the like, the data collection processing unit 25a collects the detailed data of the order approval process that flows through the ESB, and obtains the slip number from the detailed data. Similarly, the data collection processing unit 25a collects the detailed data of a shipping instruction process and a shipping approval instruction process to which a slip number the same as that on the detailed data of the order acceptance process is specified, from the ESB, and obtains the slip number from each piece of the detailed data.

The data normalization processing unit 25b then determines a registration destination of the data based on a work process name on the detailed data collected by the data collection processing unit 25a. The data normalization processing unit 25b then normalizes the detailed data by assigning the slip number obtained from the detailed data thereto as a link key, and registers the detailed data into the database (Step S802).

More specifically, if the work process name of the detailed data is an “order entry”, the data normalization processing unit 25b determines that the detailed data needs to be registered in the work procedure record detailed database 24c as a work procedure, and registers the detailed data normalized by assigning the slip number thereto as a link key into the work procedure record detailed database 24c.

When the data collection processing unit 25a collects the detailed data of the order approval process to which a slip number the same as that on the detailed data of the order entry process is specified, from the ESB, the data normalization processing unit 25b determines that the detailed data needs to be registered in the work procedure record detailed database 24c as a work procedure. The data normalization processing unit 25b then registers the detailed data normalized by assigning the slip number thereto as a link key in the work procedure record detailed database 24c. Because the order acceptance process is defined by the “order approval”, the data normalization processing unit 25b determines that the detailed data up to the order approval process needs to be registered in the defined work detailed database 24b as well, and registers the detailed data normalized by assigning the slip number thereto as a link key into the defined work detailed database 24b.

Similarly, when each piece of the detailed data of a shipping process (shipping instruction execution process and shipping approval execution process) to which a slip number the same as that on the detailed data of the order acceptance process (order entry process and order approval process) is specified, is collected from the ESB, the data normalization processing unit 25b obtains the slip number from the detailed data. The data normalization processing unit 25b then determines a registration destination of the data based on a work process name on each piece of the detailed data, and registers the detailed data normalized by assigning the slip number obtained from the detailed data thereto as a link key, in the defined work detailed database 24b or the work procedure record detailed database 24c.

The processes performed by the data collection processing unit 25a and the data normalization processing unit 25b are repeatedly executed while the power of the data verifying device 20 is turned on.

With reference to FIG. 9, a processing flow of the verification according to the first embodiment will be described. As represented in the flowchart, for example, on receiving an execution instruction of a verification process from an administrator or the like (YES at Step S901), the data verification processing unit 25c reads a series of data linked by a link key from the defined work detailed database 24b (Step S902).

The data verification processing unit 25c then rearranges the series of data read from the defined work detailed database 24b based on the verification process setting master of the verification dictionary master (see FIG. 3) (Step S903). For example, if a series of data formed by the detailed data on “order acceptance”, the detailed data on “shipping”, and the detailed data on “collection of payment” listed under the account title “sales” is to be verified, the data verification processing unit 25c rearranges the read series of data in the sequence of “order acceptance”, “shipping”, and “collection of payment”. This is carried out based on the processing order set for the “sales” of the check item “title” of the verification process setting master (for example, if the condition is “order acceptance”, the processing order is “1”; if the condition is “shipping”, the processing order is “2”; and if the condition is “collection of payment”, the processing order is “3”).

After rearranging the series of data, the data verification processing unit 25c verifies if a problem occurs with the consistency of the rearranged series of data (Step S904). For example, the data verification processing unit 25c compares the processing dates (such as a date on a slip) in the descending order, and verifies discrepancies between old and new processing dates (for example, a discrepancy occurs when the processing date of “collection of payment” is later than the processing date of “shipping”), a part of work processes missing from the series of data (such as missing of data on a “work process” of shipping), and mismatching data elements among some pieces of data (such as mismatching product names and clients), for example (see FIG. 4).

As a result of verification, if a problem occurs with the consistency of the series of data (YES at Step S904), the data verification processing unit 25c writes check information in the defined work detailed database 24b, for the data that has a problem with consistency. After writing the check information, or if no problem occurs with the consistency of the series of data (NO at Step S904), the data verification processing unit 25c confirms if a readable series of data exists (Step S906). As a result of confirmation, if a readable series of data exists (YES at Step S906), the data verification processing unit 25c continuously reads the readable series of data from the defined work detailed database 24b, and as described above, verifies if a problem occurs with the consistency of the series of data (Step S904).

As a result of confirmation, if no readable series of data exists (NO at Step S906), the data verification processing unit 25c reads the detailed data to which check information is written from the defined work detailed database 24b, and for example, as depicted in FIG. 7, outputs the verification result including the processing date that is the date on a slip, specific checked items, and the slip number (Step S907).

The use of the data verification processing unit 25c is not limited to verifying the consistency of the pieces of detailed data. Based on the verification condition setting master of the verification dictionary master (see FIG. 3), the data verification processing unit 25c may verify the consistency of the content of each piece of the detailed data (e.g., each piece of the detailed data associated with work processes such as “order acceptance” and “shipping”) that forms the series of data. If the read detailed data includes detailed data with an account title “travel expense”, the data verification processing unit 25c checks the amount, and for example, if the amount is equal to or more than one hundred thousand yen, writes check information in the defined work detailed database indicating that the data has a problem with consistency.

As described above, according to the first embodiment, data is collected for each work processing unit (such as order acceptance and shipping), and when data associated with a work process in a subsequent stage that has taken over a work process in a prior stage is collected, the data is normalized by assigning link information (e.g., a link key) to link the data associated with the work process in the prior stage and the data associated with the work process in the subsequent stage as a series of data (such as a series of data including order acceptance data, shipping data, and sales data). The data associated with the work process is stored with the link information, the series of data linked by the link information is read from a plurality of pieces of stored data, the consistency of the series of data is verified based on certain verification conditions, and the verification result is output. In other words, based on information to link the series of data, the series of data that has taken over the work process is extracted from the stored data, and the consistency of the series of data is verified based on certain verification conditions (such as conditions whether data is recorded in the sequence of order acceptance, shipping, and sales) including a work process sequence and work process content. Accordingly, it is possible to easily verify data associated with intra-firm dealings or the like that have been handled manually, and to verify the consistency of the pieces of data.

According to the first embodiment, not only the consistency of the series of data, but also specific content of each piece of the data that forms the series of data can be verified.

In the first embodiment, information that indicates the degrees of concealability, generality, and risk (for example, information that indicates the “low”, the “medium”, and the “high” degrees of risk) may also be stored in the pieces of data stored in the defined work detailed database 24b. In a second embodiment, a configuration of a data verifying device according to the second embodiment and the processing performed thereby are described, followed by advantages achieved by the second embodiment.

A configuration of the data verifying device according to the second embodiment will be described. The data verifying device according to the second embodiment has a configuration (processing function) basically the same as that of the data verifying device according to the first embodiment, and also has different points as described below.

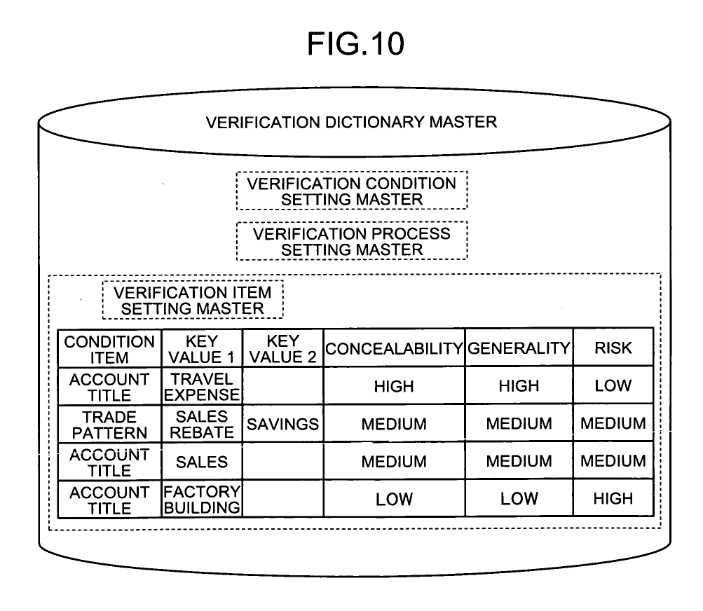

The verification dictionary master 24a not only includes the verification condition setting master and the verification process setting master, but also includes, as depicted in FIG. 10, a verification item setting master.

The verification item setting master, in association with condition items (such as an “account title” and a “client”) of the verification process, and a key value (such as the key value 1 “travel expense” and the key value 2 “savings”) to narrow down data, stores therein information to set the information indicating the degrees of concealability, generality, and risk (for example, if the data is a travel expense in the account title, information to set the concealability to “high”, the generality to “high”, and the risk to “low”). The verification item setting master may be suitably set by a user.

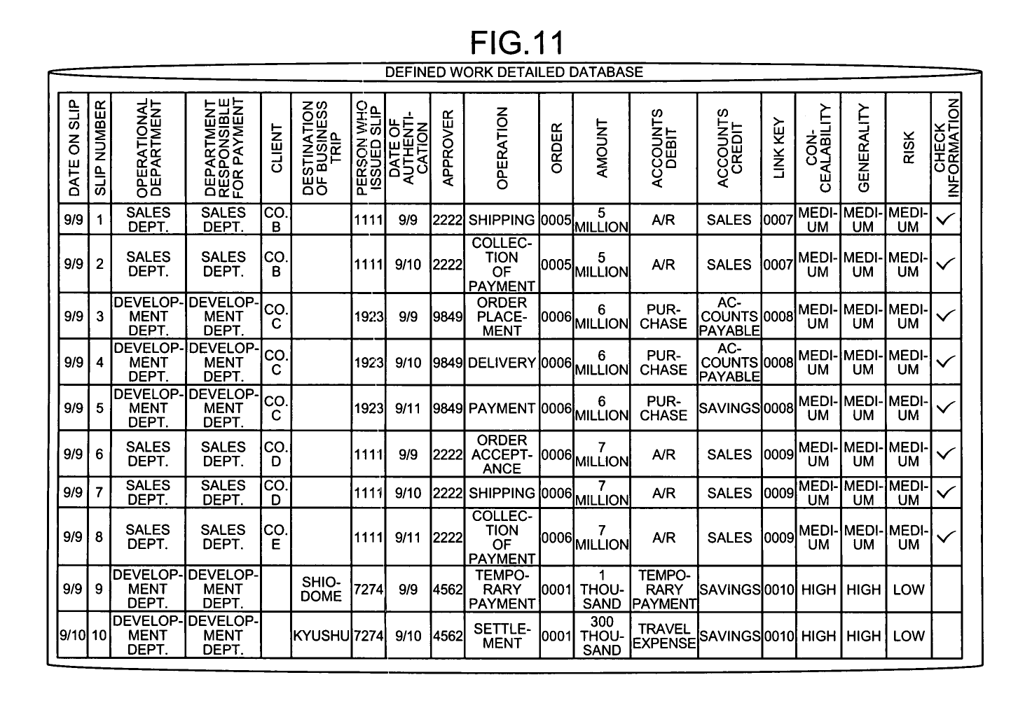

An application of the verification item setting master will be described in detail. The data verification processing unit 25c reads, for example, on receiving an execution instruction of a verification process from an administrator or the like, a series of data linked by a link key from the defined work detailed database 24b. As depicted in FIG. 11, by checking the read series of data against the verification item setting master, the data verification processing unit 25c sets information that indicates the degrees of concealability, generality, and risk (for example, if the data is a travel expense in the account title, the concealability is set to “high”, the generality is set to “high”, and the risk is set to “low”).

As explained in the first embodiment, based on the verification process setting master of the verification dictionary master (see FIG. 3), the data verification processing unit 25c rearranges the series of data read from the defined work detailed database 24b, and verifies the consistency of the series of data, for example. More specifically, on finishing the verification process for the consistency of the series of data, the data verification processing unit 25c, for example, extracts each piece of the detailed data whose concealability is set to “high” from the series of data. Then, based on the verification condition setting master of the verification dictionary master (see FIG. 3), the data verification processing unit 25c verifies the consistency of the content of each piece of the detailed data (e.g., each piece of the detailed data associated with work processes such as “order acceptance” and “shipping”). For example, the data verification processing unit 25c extracts the detailed data of the “travel expense” in the account title whose concealability is set to “high” from the series of data, checks the amount, and if the amount is equal to or more than one hundred thousand yen, writes check information in the defined work detailed database indicating that the data has a problem with consistency.

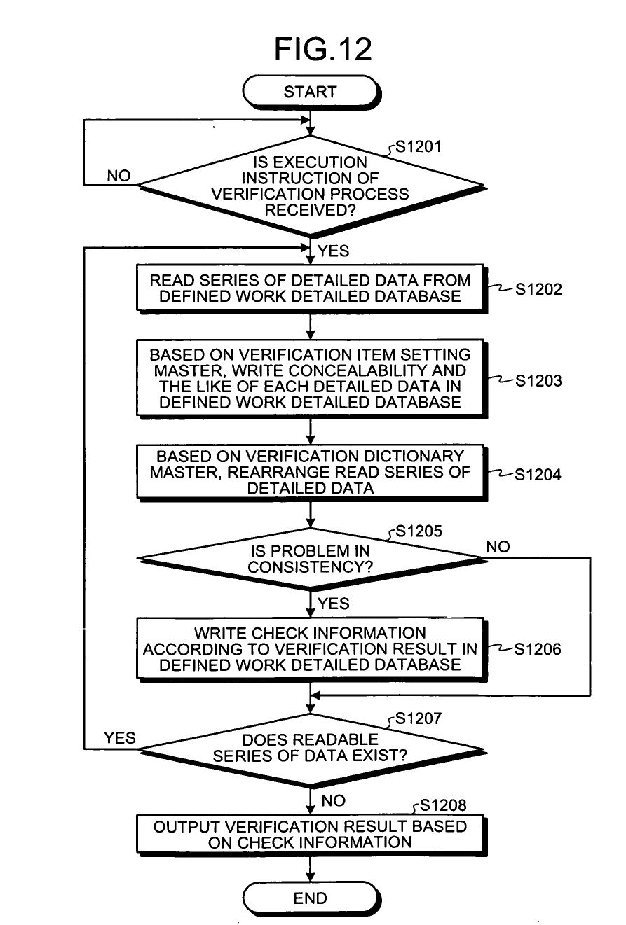

With reference to FIG. 12, a processing flow of the verification according to the second embodiment will be described. Processes performed at Step S1201, Step S1202, Step S1204, and at Steps S1206 to S1208 depicted in the flowchart are the same as the processes performed at Steps S901 to S903 and at Steps S904 to S907 described in the first embodiment with reference to FIG. 9. However, processes performed at Step S1203 and Step S1205 described below are different from the first embodiment.

In other words, the data verification processing unit 25c reads, for example, on receiving an execution instruction of the verification process from an administrator or the like, a series of data linked by a link key from the defined work detailed database 24b (Step S1202) as described in the first embodiment. Then, as depicted in FIG. 11, by checking the read series of data against the verification item setting master, the data verification processing unit 25c sets information that indicates the degrees of concealability, generality, and risk (for example, if the data is a travel expense in the account title, the concealability is set to “high”, the generality is set to “high”, and the risk is set to “low”) (Step S1203).

As explained in the first embodiment, based on the verification process setting master of the verification dictionary master (see FIG. 3), after rearranging the series of data read from the defined work detailed database 24b, the data verification processing unit 25c verifies the consistency of the series of data, for example (Step S1205). More specifically, on finishing the verification process for the consistency of the series of data, the data verification processing unit 25c, for example, extracts the detailed data whose concealability is set to “high” from the series of data, and based on the verification condition setting master of the verification dictionary master (see FIG. 3), verifies the consistency of the content of each piece of the detailed data (e.g., each piece of the detailed data associated with work processes such as “order acceptance” and “shipping”). For example, the data verification processing unit 25c extracts the detailed data of a “travel expense” in the account title whose concealability is set to “high” from the series of data, checks the amount, and if the amount is equal to or more than one hundred thousand yen, writes check information in the defined work detailed database indicating that the data has a problem with consistency.

As described above, according to the second embodiment, in association with condition items (such as an “account title” and a “client”) of the verification process, and a key value (such as the key value 1 “travel expense” and the key value 2 “savings”) to narrow down data, information to set the information indicating the degrees of concealability, generality, and risk (for example, if the data is a travel expense in the account title, information to set the concealability to “high”, the generality to “high”, and the risk to “low”) is stored. According to the second embodiment, based on the stored information that indicates the degrees of concealability, generality, and risk (such as information that indicates the “low”, the “medium”, and the “high” degrees of risk), a piece of data is extracted from the pieces of stored data. Because the content of the extracted data is verified based on the verification condition setting master, it is possible to efficiently verify data that is highly likely to have a problem with its content.

In the above described embodiments, while normalizing the pieces of data collected for each work processing unit in the various types of operations, each piece of the data may be converted into a form unified by a data item (e.g., an item associated with a work process, such as a dealing date, a client, and a destination of a business trip) common to work processing units. In the third embodiment, a configuration of a data verifying device according to the third embodiment and the processing performed thereby are described sequentially, followed by advantages of the third embodiment.

A configuration of the data verifying device according to the third embodiment will be described. The data verifying device according to the third embodiment has a configuration (processing function) basically the same as that of the data verifying device according to the above-described embodiments, and also has different points as described below.

The data normalization processing unit 25b not only determines a registration destination of data based on a work process name on the detailed data collected by the data collection processing unit 25a, and assigns the slip number obtained from the detailed data thereto as a link key, but also normalizes the data by converting a format of the data into a form unified by a data item (e.g., an item associated with a work process, such as a dealing date, a client, and a destination of a business trip) common to work processing units, and registers the data into the database.

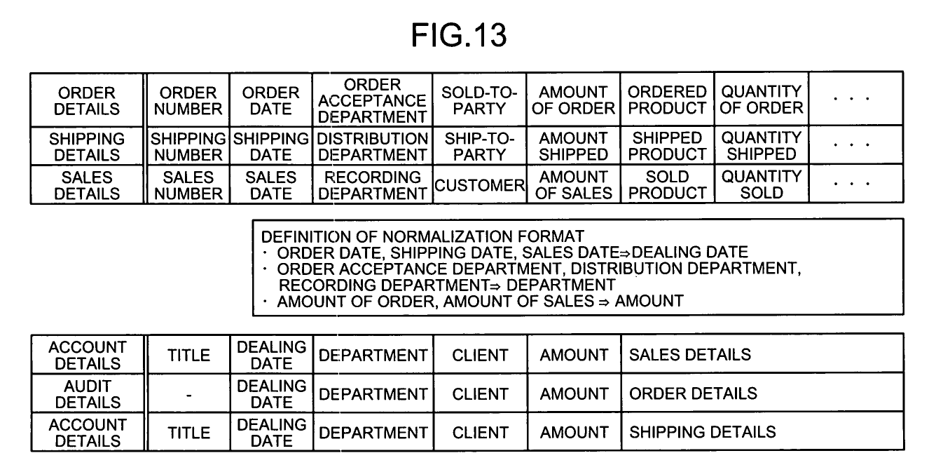

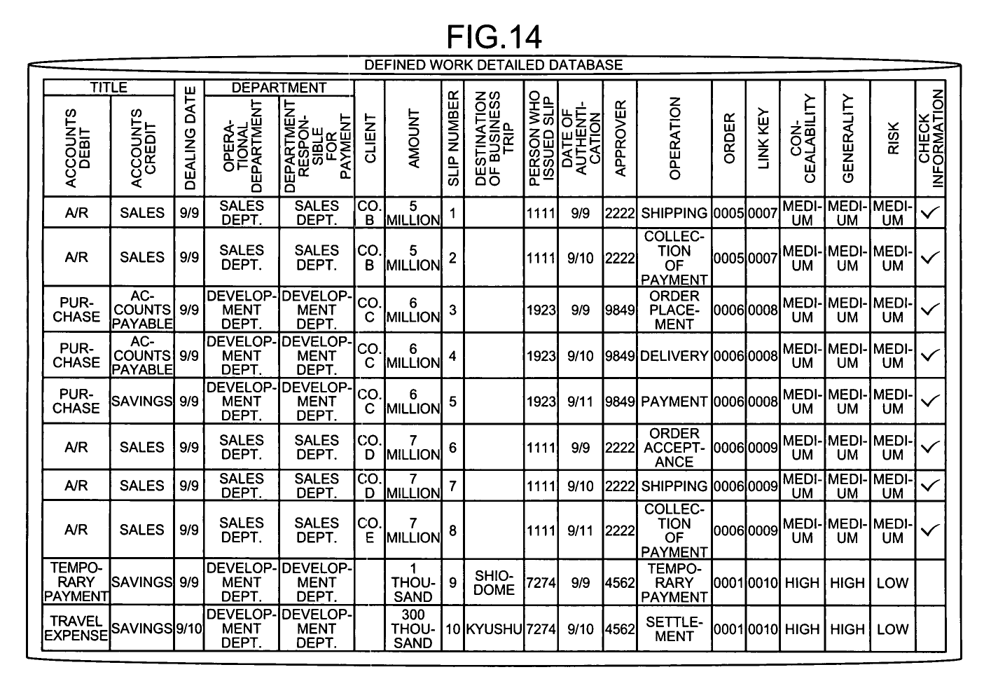

More specifically, as depicted in FIG. 13, the data normalization processing unit 25b normalizes, based on a definition of a normalization format included therein, data by arranging an item “title” in the detailed data at the top, arranging and uniformly converting items in which the detailed data such as an “order date”, a “shipping date”, and a “sales date” are registered into an item “dealing date”, and arranging and uniformly converting items in which the detailed data such as an “order acceptance department”, a “distribution department”, and a “recording department” are registered into an item “department”. The data normalization processing unit 25b then arranges and uniformly converts items in which the detailed data such as an “amount of order” and an “amount of sales” are registered into an item “amount”, and arranges other items in which the remaining detailed data is registered. As depicted in FIG. 14, the data normalization processing unit 25b registers the normalized detailed data into the defined work detailed database 24b determined as the registration destination.

The data verification processing unit 25c, for example, reads a plurality of pieces of detailed data stored in a certain period of time (e.g., a period of time to verify detailed data, such as one month) for each data item (such as a dealing date and a client) whose format has been converted, from the pieces of detailed data stored in the defined work detailed database 24b. The data verification processing unit 25c then verifies the consistency of the pieces of read detailed data based on certain verification conditions (for example, by comparing the total value obtained by adding the number of dealings with the same client per month with a certain reference value). As a result of verification, if a problem occurs with the consistency (if the difference is large compared with the reference value, for example, when the number of dealings with the same client is extremely large), the data verification processing unit 25c writes check information in the defined work detailed database 24b.

The date normalization processing unit 25b may automatically register, while converting the format, the work process name in the item “operation” in the defined work detailed database 24b based on the work process name on the detailed data collected by the data collection processing unit 25a.

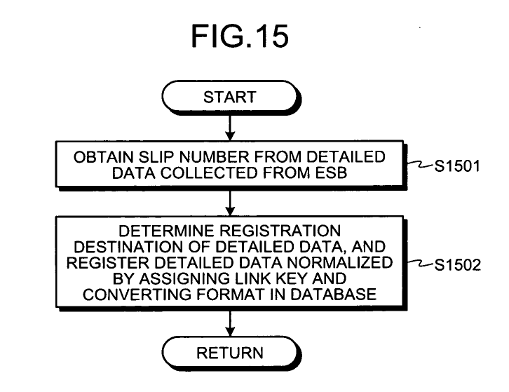

With reference to FIG. 15, a processing flow of normalization of the detailed data according to the third embodiment will be described. The process performed at Step S1501 in the flowchart is the same process as performed at Step S801 described in the first embodiment with reference to FIG. 8. However, a process performed at Step S1502 described below is different from the first embodiment.

In other words, the data normalization processing unit 25b not only determines a registration destination of data based on a work process name on the detailed data collected by the data collection processing unit 25a, and assigns the slip number obtained from the detailed data thereto as a link key, but also normalizes the data by converting a format of the data into a form unified by a data item (e.g., an item associated with a work process, such as a dealing date, a client, and a destination of a business trip) common to work processing units, and registers the data into the database (Step S1502).

More specifically, as depicted in FIG. 13, the data normalization processing unit 25b normalizes, based on the definition of a normalization format included therein, data by arranging an item “title” in the detailed data at the top, arranging and uniformly converting items in which the detailed data such as an “order date”, a “shipping date”, and a “sales date” are registered into an item “dealing date”, and arranging and uniformly converting items in which the detailed data such as an “order acceptance department”, a “distribution department”, and a “recording department” are registered into an item “department”. The data normalization processing unit 25b then arranges and uniformly converts items in which the detailed data such as an “amount of order” and an “amount of sales” are registered into an item “amount”, and arranges other items in which the remaining detailed data is registered. As depicted in FIG. 14, the data normalization processing unit 25b registers the normalized detailed data into the defined work detailed database 24b determined as the registration destination.

As described above, according to the third embodiment, when normalizing the pieces of data collected for each work processing unit in various types of operations, each piece of the data is converted into a form unified by a data item (e.g., an item associated with a work process, such as a dealing date, a client, and a destination of a business trip) common to work processing units, and for example, a plurality of pieces of detailed data stored in a certain period of time (e.g., a period of time to verify detailed data, such as one month) is read for each data item (such as a dealing date and a client) whose format has been converted, from the pieces of detailed data stored in the defined work detailed database 24b. Because the consistency of the pieces of read detailed data is verified based on certain verification conditions (for example, by comparing the total value obtained by adding the number of dealings with the same client per month with a certain reference value), for example, it is possible to easily read the data associated with the work processes performed in a certain period of time for each data item, and to efficiently verify the consistency of the pieces of data.

While embodiments of the present invention have been described, it is to be understood that various other modifications may be made in addition to the embodiments of the present invention. Other embodiments included in the present invention will now be described.

According to the above-described embodiments, the verification of the consistency of a plurality of pieces of detailed data is mainly explained. However, the present invention is not limited to this, and it is also possible to verify the detailed data associated with a single work process in which the operation is completed without being taken over to the work process in a subsequent stage, for example, based on the verification condition setting master (see FIG. 3).

In this manner, not only the consistency of a series of data, but also specific content of the detailed data (such as travel expense) associated with the work process completed independently can be verified.

According to the above-described embodiments, the data collection processing unit 25a may only collect data used for verifying a plurality of pieces of detailed data. Accordingly, there is no need to narrow down required data, while the work operation record data such as “activation of a screen”, a “person who issued a slip”, and a “name of a slip issuing terminal” irrelevant to the verification of the detailed data is collected. Accordingly, it is possible to efficiently execute the verification of the pieces of detailed data.

The respective components of the data verifying device 20 depicted in FIG. 5 are functionally conceptual, and need not necessarily be physically configured as illustrated. In other words, the specific mode of dispersion and integration of the data verifying device 20 is not limited to those depicted in the drawings, and all or a part thereof can be functionally or physically dispersed or integrated in an optional unit, depending on various kinds of load and the status of use, for example, by integrating the data collection processing unit 25a and the data normalization processing unit 25b, or by dispersing the processing functions realized by the data collection processing unit 25 and the data normalization processing unit 25b to other devices. All or an optional part of the processing functions (the data collection processing function, the data normalization processing function, and the data verification processing function; see FIGS. 8 and 9, for example) carried out by the data verifying device 20 can be realized by a central processing unit (CPU) and a computer program analyzed and executed by the CPU, or can be realized as hardware by wired logic.

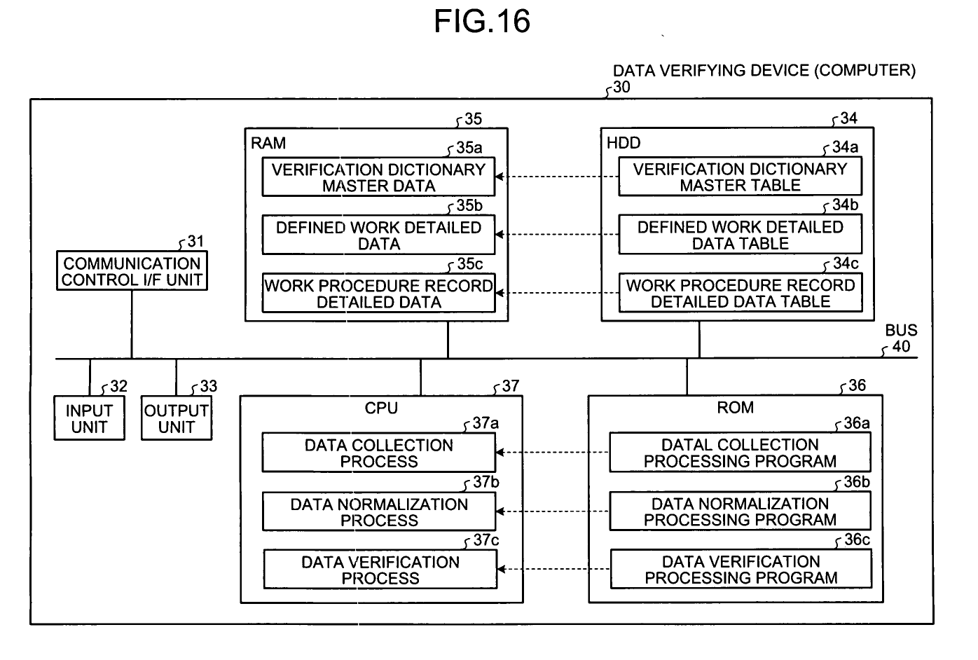

(4) Various types of processing (for example, see FIGS. 8, 9, 12, and 15) operated by the data verifying device described in the above-described embodiments can be realized by executing prepared computer programs with a computer system such as a personal computer and a work station. Referring to FIG. 16, an example of a computer that executes a data verifying program having a function similar to that of the data verifying device explained in the embodiments will now be described. FIG. 16 is a schematic of a computer that executes the data verifying program.

As depicted in FIG. 16, a computer 30 that is a data verifying device is configured to be connected to a communication control I/F unit 31, an input unit 32, an output unit 33, a hard disk drive (HDD) 34, a random access memory (RAM) 35; a read-only memory (ROM) 36, and a CPU 37 via a bus 40. The communication control I/F unit 31, the input unit 32, and the output unit 33, for example, respectively correspond to the communication control I/F unit 21, the input unit 22, and the output unit 23 of the data verifying device 20 depicted in FIG. 5.

In the ROM 36, a data verifying program that can exercise a function similar to that of the data verifying device explained in the above embodiments is stored in advance. In other words, as depicted in FIG. 16, a data collection processing program 36a, a data normalization processing program 36b, and a data verification processing program 36c are stored in the ROM 36 in advance. The programs 36a, 36b, and 36c may be integrated or dispersed appropriately, for example, like the respective components of the data verifying device 20 depicted in FIG. 5. The ROM 36 may be a non-volatile “RAM”.

The CPU 37 reads the programs 36a, 36b, and 36c from the ROM 36 as depicted in FIG. 16, and thus the programs 36a, 36b, and 36c function as a data collection process 37a, a data normalization process 37b, and a data verification process 37c, respectively. The processes 37a, 37b, and 37c, for example, respectively correspond to the data collection processing unit 25a, the data normalization processing unit 25b, and the data verification processing unit 25c of the data verifying device 20 depicted in FIG. 5.

The HDD 34, as depicted in FIG. 16, includes a verification dictionary master table 34a, a defined work detailed data table 34b, and a work procedure record detailed data table 34c. The verification dictionary master table 34a, the defined work detailed data table 34b, and the work procedure record detailed data table 34c, for example, respectively correspond to the verification dictionary master 24a, the defined work detailed database 24b, and the work procedure record detailed database 24c depicted in FIG. 5. The CPU 37 reads verification dictionary master data 35a, defined work detailed data 35b, and work procedure record detailed data 35c from the verification dictionary master table 34a, the defined work detailed data table 34b, and the work procedure record detailed data table 34c, and stores them in the RAM 35. The CPU 37 then executes the process based on the verification dictionary master data 35a, the defined work detailed data 35b, and the work procedure record detailed data 35c stored in the RAM 35.

The programs 36a, 36b, and 36c need not be stored in the ROM 36 in advance. For example, the programs 36a, 36b, and 36c may be stored in a “portable physical medium” such as a flexible disk (FD), a compact disk read only memory (CD-ROM), a digital versatile disk (DVD), a magneto optical disk, and an integrated circuit (IC) card that can be inserted into the computer 30; in a “fixed physical medium” such as an HDD provided inside and outside of the computer 30; or in “another computer (or server)” connected to the computer 30 via a public line, the Internet, a local area network (LAN), or a wide area network (WAN). The computer 30 can read each computer program therefrom, and execute it.

According to the embodiments, it is possible to easily verify data associated with intra-firm dealings or the like that have been handled manually, and to verify the consistency of a plurality of pieces of data.

According to the embodiments, it is possible to easily read data associated with work processes performed in a certain period of time for each data item, and to efficiently verify the consistency of a plurality of pieces of data.

According to the embodiments, there is no need to narrow down required data while the work operation record data such as “activation of a screen”, a “person who issued a slip”, and a “name of a slip issuing terminal” irrelevant to the verification of the detailed data is collected. Accordingly, it is possible to efficiently execute the verification of a plurality of pieces of detailed data.

According to the embodiments, not only the consistency of a series of data, but also specific content of each piece of the data that forms the series of data and data (such as travel expense) in which the work process is completed independently can be verified.

According to the embodiments, it is possible to efficiently verify data that is highly likely to have a problem with its content.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A data verifying device that verifies data in a work process, for a work service including a plurality of stages of work processes, the data verifying device comprising:
a data collecting unit that collects data for each work processing unit;
a data normalizing unit that, when the data collecting unit collects data associated with a work process in a subsequent stage that has taken over a work process in a prior stage, normalizes the data by assigning link information to link the data associated with the work process in the prior stage and the data associated with the work process in the subsequent stage as a series of data;
a data storage unit that stores therein data associated with the work process with the link information assigned by the data normalizing unit;
a data verifying unit that reads the series of data linked by the link information from a plurality of pieces of data stored in the data storage unit, and verifies consistency of the series of data based on a predetermined verification condition; and
a verification result output unit that outputs a verification result obtained by the data verifying unit.

2. The data verifying device according to claim 1, further comprising:
a verification condition storage unit that, for each set item being set while verifying the data in the work process, stores therein a verification condition including a work process sequence and work process content, wherein
the data verifying unit verifies, based on the verification condition stored in the verification condition storage unit, the consistency of the series of data read from the pieces of data stored in the data storage unit for each set item.

3. The data verifying device according to claim 2, wherein
the verification condition storage unit further stores therein, for each verification item to verify data content in the work process, an individual verification condition including narrowing-down information used to narrow down data to be verified and verification content, and
the data verifying unit verifies, based on the individual verification condition stored in the verification condition storage unit, content of a single piece of data that forms a group of the series of data read from the pieces of data stored in the data storage unit.

4. The data verifying device according to claim 1, wherein
the data normalizing unit converts, when the pieces of data collected by the data collecting unit is to be normalized, each piece of the data into a form unified by a data item common to the work processing unit, and
the data verifying unit reads the pieces of data stored in a predetermined period of time from the pieces of data stored in the data storage unit for each data item, and verifies the consistency of the pieces of read data based on the predetermined verification condition.

5. The data verifying device according to claim 1, wherein the data collecting unit only collects data used for verifying the series of data.

6. The data verifying device according to claim 3, wherein
the verification condition storage unit further stores therein, in association with the verification item and the narrowing-down information, scale information that indicates a required scale of verification set for each characteristic of work process content, the data verifying device further comprising:
a data extracting unit that, based on the scale information stored in the verification condition storage unit, extracts a piece of data from the pieces of data stored in the data storage unit, wherein
the data verifying unit verifies, based on the individual verification condition stored in the verification condition storage unit, each data content extracted by the data extracting unit.

7. A data verifying method that verifies data in a work process, for a work service including a plurality of stages of work processes, the data verifying method comprising:
collecting data for each work processing unit;
normalizing, when collecting data associated with a work process in a subsequent stage that has taken over a work process in a prior stage, the data by assigning link information to link the data associated with the work process in the prior stage and the data associated with the work process in the subsequent stage as a series of data;
storing in a storage unit data associated with the work process with the link information assigned by the normalizing;
reading the series of data linked by the link information from a plurality of pieces of data stored in the storage unit, and verifying consistency of the series of data based on a predetermined verification condition; and
outputting a verification result obtained by the verifying.

8. The data verifying method according to claim 7, further comprising:
storing, for each set item being set while verifying the data in the work process, in the storage unit a verification condition including a work process sequence and work process content; and
verifying, based on the verification condition stored in the storage unit, the consistency of the series of data read from the pieces of data stored in the storage unit for each set item.

9. The data verifying method according to claim 8, wherein
storing in the storage unit, for each verification item to verify data content in the work process, an individual verification condition including narrowing-down information used to narrow down data to be verified and verification content, and
verifying, based on the individual verification condition stored in the storage unit, content of a single piece of data that forms a group of the series of data read from the pieces of data stored in the data storage unit.

10. The data verifying method according to claim 7, wherein
converting, when the pieces of data collected by the collecting is to be normalized, each piece of the data into a form unified by a data item common to the work processing unit, and
reading the pieces of data stored in a predetermined period of time from the pieces of data stored in the storage unit for each data item, and verifying the consistency of the pieces of read data based on the predetermined verification condition.

11. The data verifying method according to claim 7, wherein collecting only data used for verifying the series of data.

12. The data verifying method according to claim 9, wherein
storing, when data associated with a single work process is collected at the data collecting, the data associated with the single work process in the storage unit, and
verifying, based on the individual verification condition stored in the storage unit at the verification condition storing, data content associated with the single work process stored in the storage unit.

13. The data verifying method according to claim 9, wherein
storing in the storage unit, in association with the verification item and the narrowing-down information, scale information that indicates a required scale of verification set for each characteristic of work process content,
extracting, based on the scale information stored in the storage unit, a piece of data from the pieces of data stored in the storage unit, and
verifying, based on the individual verification condition stored in the storage unit, each data content extracted by the extracting.

14. A computer readable storage medium containing instructions that, when executed by a computer, causes the computer to perform a data verifying process that verifies data in a work process, for a work service including a plurality of stages of work processes, the computer to perform:
collecting data for each work processing unit;
normalizing, when collecting data associated with a work process in a subsequent stage that has taken over a work process in a prior stage, the data by assigning link information to link the data associated with the work process in the prior stage and the data associated with the work process in the subsequent stage as a series of data;
storing in a storage unit data associated with the work process with the link information assigned by the normalizing;
reading the series of data linked by the link information from a plurality of pieces of data stored in the storage unit, and verifying consistency of the series of data based on a predetermined verification condition; and
outputting a verification result obtained by the verifying.

15. The computer readable storage medium according to claim 14, further comprising:
storing, for each set item being set while verifying the data in the work process, in the storage unit a verification condition including a work process sequence and work process content; and
verifying, based on the verification condition stored by the storage unit, the consistency of the series of data read from the pieces of data stored in the storage unit for each set item.

16. The computer readable storage medium according to claim 15, wherein
storing in the storage unit, for each verification item to verify data content in the work process, an individual verification condition including narrowing-down information used to narrow down data to be verified and verification content, and
verifying, based on the individual verification condition stored in the storage unit, content of a single piece of data that forms a group of the series of data read from the pieces of data stored in the data storage unit.

17. The computer readable storage medium according to claim 14, wherein
converting, when the pieces of data collected by the collecting is to be normalized, each piece of the data into a form unified by a data item common to the work processing unit, and
reading the pieces of data stored in a predetermined period of time from the pieces of data stored in the storage unit for each data item, and verifying the consistency of the pieces of read data based on the predetermined verification condition.

18. The computer readable storage medium according to claim 14, wherein collecting only data used for verifying the series of data.

19. The computer readable storage medium according to claim 16, wherein
storing, when data associated with a single work process is collected at the data collecting, the data associated with the single work process in the storage unit, and
verifying, based on the individual verification condition stored in the storage unit at the verification condition storing, data content associated with the single work process stored in the storage unit.

20. The computer readable storage medium according to claim 16, wherein
storing in the storage unit, in association with the verification item and the narrowing-down information, scale information that indicates a required scale of verification set for each characteristic of work process content,
extracting, based on the scale information stored in the storage unit, a piece of data from the pieces of data stored in the storage unit, and
verifying, based on the individual verification condition stored in the storage unit, each data content extracted by the extracting.
